(19) United States
(12) Patent Application Publication
(10) Pub. No.: US 2017/0357951 A1
(43) Pub. Date: Dec. 14, 2017

(54) AUTHORIZING CANCELLED MEETING ROOM ACTION

(71) Applicant: International Business Machines Corporation, Armonk, NY (US)

(72) Inventors: Apurva S. Patel, Pune (IN); Maitreyee M. Patukale, Pune (IN); Prasad P. Purandare, Pune (IN); Debasish Roy, Pune (IN)

(21) Appl. No.: 15/660,324

(22) Filed: Jul. 26, 2017

Related U.S. Application Data
(63) Continuation of application No. 15/182,127, filed on Jun. 14, 2016.

(51) Int. Cl. G06Q 10/10; H04L 12/58; H04L 29/08

(52) U.S. Cl. CPC G06Q 10/1095; H04L 67/104; H04L 51/26

(57) ABSTRACT

An approach for authorizing a cancelled meeting room action includes receiving a notification of an unavailable meeting room for a scheduled meeting and determining a meeting context for the scheduled meeting based, on at least one of a meeting subject, a meeting agenda, a plurality of meeting minutes, or one or more meeting action items using at least one of natural language processing or semantic analysis. The approach includes determining whether an elapse time for a meeting room action is past for the scheduled meeting. When the elapse time is past, determining a first invitee on a prioritized list of a plurality of meeting invitees to provide with a temporary meeting room action authorization. The approach includes sending to the first invitee, a notification of the temporary meeting room action authorization for the scheduled meeting and determining whether the first invitee has performed a meeting room action.

### BACKGROUND OF THE INVENTION

The present invention relates generally to the field of calendar-based scheduling for a group of meeting invitees and more particularly to determining a meeting invitee to re-schedule a cancelled meeting room.

Meeting rooms, when scheduled via a computer network or other electronic means, are typically reserved by a meeting chair or other responsible meeting organizer using an electronic meeting scheduling service or application. Meeting room availability is typically determined from information retrieved by the meeting scheduling service from a meeting room database. As meeting room reservations are processed using meeting scheduling services, meeting room availability is updated and stored in the meeting room database.

### SUMMARY

Embodiments of the present invention disclose a method, for authorizing a cancelled meeting room action. The method includes one or more computer processors receiving a notification of an unavailable meeting room for a scheduled meeting. The method includes the one or more computer processors determining a meeting context based, at least in part, on at least one of a meeting subject, a meeting agenda, a plurality of meeting minutes, or one or more meeting action items using at least one of natural language processing or semantic analysis. Furthermore, the method includes the one or more computer processors determining whether an elapse time for a meeting room action is past for the scheduled meeting with the unavailable meeting room. Responsive to determining the elapse time for the meeting room action is past for the scheduled meeting with the unavailable meeting room, the method includes the one or more computer processors determining a first invitee on a prioritized list of a plurality of meeting invitees to the scheduled meeting to provide with a temporary meeting room action authorization. The method includes the one or more computer processors providing the prioritized list in ascending order wherein the prioritized list is in ascending order from a most relevant invitee to a least relevant invitee to the scheduled meeting. The method includes the one or more computer processors determining the prioritized list in ascending order wherein the ascending order is determined by at least one of a comparison of information on each invitee of the plurality of meeting invitees to one or more of the meeting context, an invitee length of time on a project associated with a meeting subject of the scheduled meeting, or an invitee availability, wherein the comparison of information is based, at least in part, on one of a correlation of a number of key words in the retrieved information matching one or more key words in the meeting context, a length of time in the project, or the most relevant invitee available for the pre-set time. Furthermore, the method includes the one or more computer processors sending to the first invitee a notification of the temporary meeting room action authorization for the scheduled meeting. Additionally, the method includes the one or more computer processors determining whether the first invitee has performed a meeting room action in a second elapse time. Responsive to determining the meeting room action is not performed for the scheduled meeting in the second elapse time, the method includes the one or more computer processors determining a second invitee on the prioritized list on the plurality of meeting invitees to provide with a temporary meeting room action authorization. The method includes the one or more computer processors sending a notification of the temporary meeting room action authorization to the second invitee.

### BRIEF DESCRIPTION OF THE DRAWINGS

FIG. 1 is a functional block diagram illustrating a distributed data processing environment, in accordance with at least one embodiment of the present invention;

FIG. 2 is a flowchart depicting operational steps of one example of a meeting room re-schedule method in accordance with at least one embodiment of the present invention;

FIGS. 3A, 3B, and 3C are illustrations depicting examples of user interface displays of e-mails and computer log data generated by a meeting room program in accordance with at least one embodiment of the present invention; and

FIG. 4 is a block diagram depicting components of a computer system in accordance with at least one embodiment of the present invention.

### DETAILED DESCRIPTION

Embodiments of the present invention recognize that occasionally a meeting room reservation is cancelled or declined when a higher priority meeting is scheduled for the same room, thus leaving a previously scheduled meeting without a meeting room. Embodiments of the present invention recognize that an electronic meeting scheduling service sends an automatic notification of the cancelled meeting room to the user or meeting chair who reserved the meeting room. The notification may go unnoticed or unacted upon due to a meeting chair's absence from the office or busy schedule.

Embodiments of the present invention provide a method to determine a meeting invitee to perform a meeting room action such as re-schedule a meeting room when a meeting chair does not perform a meeting room action in a pre-set or determined elapsed time from a received notification of an unavailable meeting room. Embodiments of the present invention provide a method to create a prioritized list of the meeting invitees based, at least in part, on the relevance of the meeting invitees to the scheduled meeting context.

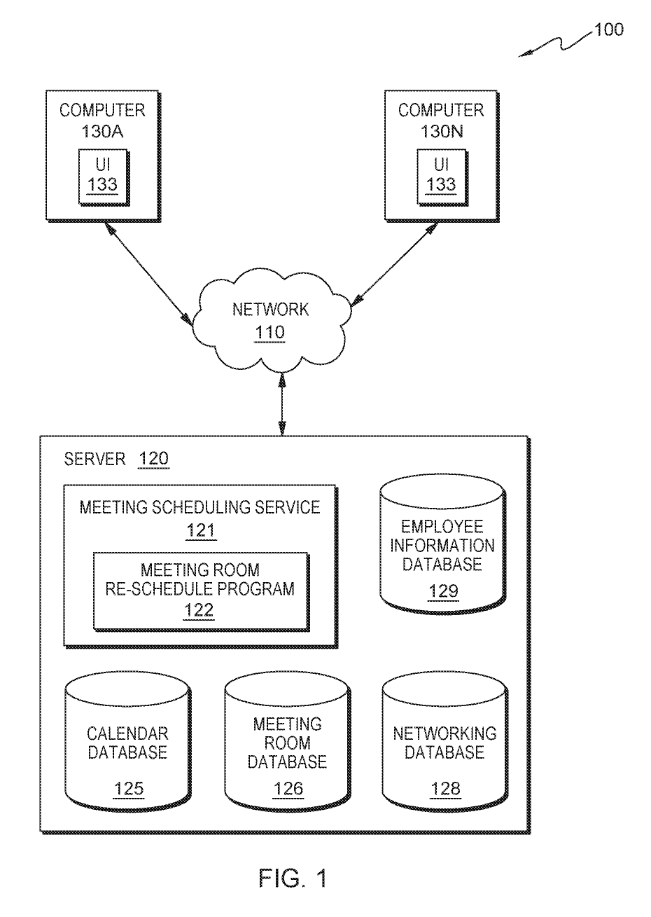

FIG. 1 is a functional block diagram illustrating a distributed data processing environment, generally designated 100, in accordance with at least one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

As depicted, distributed data processing environment 100 includes server 120 and computers 130A to computers 130N all interconnected over network 110. Network 110 can include, for example, a telecommunications network, a local area network (LAN), a virtual LAN (VLAN), a wide area network (WAN), such as the Internet, or a combination of the these, and can include wired or wireless connections. Network 110 can include one or more wired and/or wireless networks that are capable of receiving and transmitting data including receiving GPS signals or radio waves, voice, and/or video signals, including multimedia signals that include voice, data, and video information. In general, network 110 can be any combination of connections and protocols that will support communications between server 120, computers 130A-130N, and other computing devices (not shown) within distributed data processing environment 100.

Computers 130A-130N can each be one or more of a laptop computer, a tablet computer, a smart phone, or any programmable electronic device capable of communicating with various components and devices within distributed data processing environment 100, via network 110. In general, computers 130A-130N each represent any programmable electronic device or combination of programmable electronic devices capable of executing machine readable program instructions and communicating with other computing devices (not shown) within distributed data processing environment 100 via a network, such as network 110. Computers 130A-130N each include an instance of user interface 133. Computers 130A-130N access server 120 and other computer devices (not depicted in FIG. 1) via network 110, for example, to receive and generate meeting notices.

User interface 133 provides an interface for each respective user of computers 130A-130N with server 120 and other computing devices in distributed data processing environment 100 (not shown). In one embodiment, user interface 133 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. In another embodiment, user interface 133 may also be mobile application software that provides an interface between the users of computers 130A-130N and server 120. Mobile application software, or an “app,” is a computer program designed to run on smart phones, tablet computers and other mobile devices. User interface 133 enables computers 130A-130N to receive a user selection of a revised meeting room sent via network 110 to meeting scheduling service 121 on server 120.

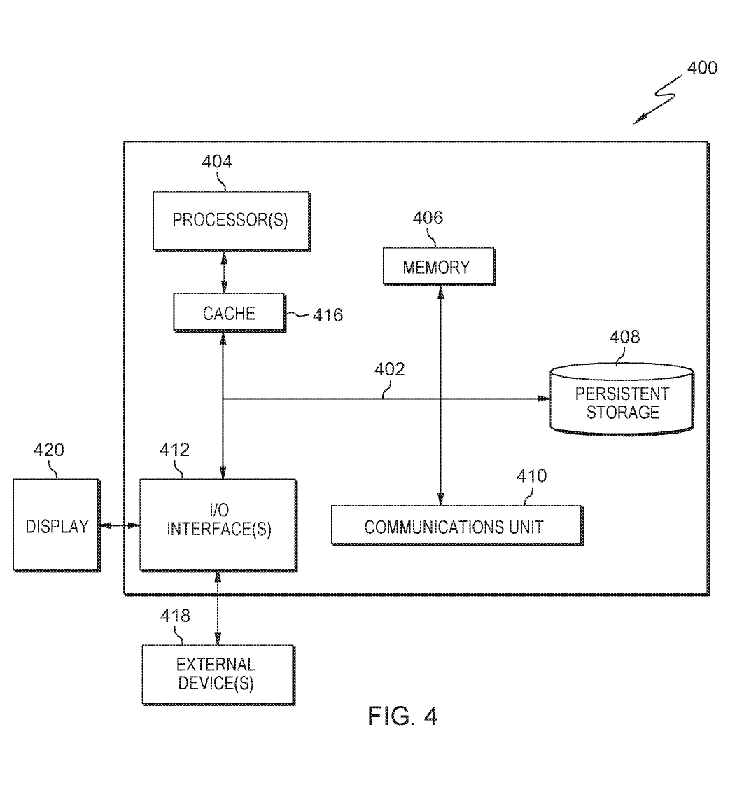

Server 120 can be a standalone computing device, a management server, a web server, a mobile computing device, or any other electronic device or computing system capable of receiving, sending, and processing data. In other embodiments, server 120 can represent a server computing system utilizing multiple computers as a server system, such as in a cloud computing environment. In another embodiment, server 120 can be a laptop computer, a tablet computer, a netbook computer, a personal computer (PC), a desktop computer, a personal digital assistant (PDA), a smart phone, or any programmable electronic device capable of communicating with computers 130A-130N, and other computing devices (not shown) within distributed data processing environment 100 via network 110. In another embodiment, server 120 represents a computing system utilizing clustered computers and components (e.g., database server computers, application server computers, etc.) that act as a single pool of seamless resources when accessed within distributed data processing environment 100. Server 120 includes meeting scheduling service 121, meeting room re-schedule program 122, calendar database 125, meeting room database 126, networking database 128, and employee information database 129. Server 120 may include internal and external hardware components, as depicted and described in further detail with respect to FIG. 4.

Meeting scheduling service 121 is any known meeting scheduling service provided by internet service providers, an e-mail system, a corporate mail service, or the like. A meeting chair or other responsible meeting organizer or user schedules a meeting using meeting scheduling service 121. Meeting scheduling service 121 generates meeting notices for invitees to the meeting and may send meeting room change or meeting cancellations to the invitees when a meeting room is re-scheduled or cancelled. Meeting scheduling service 121 generates a notification to the meeting chair and meeting room re-schedule program 122 of an unavailable meeting room for a scheduled meeting for a declined or rejected meeting room reservation.

Meeting room re-schedule program 122 determines an authorized meeting invitee to perform a meeting room action for a scheduled meeting when a notification is received of an unavailable meeting room for a previously scheduled meeting (e.g., when a scheduled meeting is bumped from a reserved meeting room). Meeting room re-schedule program 122 determines an authorized invitee to perform a meeting room action (e.g., re-schedule a meeting room) when a meeting chair who originally scheduled the meeting does not take an action to cancel or re-schedule a meeting room for the scheduled meeting in a set or pre-determined elapsed time from receipt of the notice of the unavailable room.

Meeting room re-schedule program 122 extracts information from a meeting notice of the scheduled meeting to determine a meeting context. Additionally, meeting room re-schedule program 122 extracts information on each invitee to the scheduled meeting from at least one of networking database 128, employee information database 129, or another database (not shown) containing information on the invitees. Meeting room re-schedule program 122 compares the extracted information on each invitee to the meeting context to determine a prioritized list of an invitee importance or relevance to the scheduled meeting with an unavailable or cancelled meeting room.

Additionally, meeting room re-schedule program 122 accesses information from calendar database 125 to determine availability of an invitee with the highest relevance or importance to the scheduled meeting. Meeting room re-schedule program 122 informs the invitee with the highest relevance to the meeting context who is available of an authorization to re-schedule the unavailable meeting room or cancel the meeting. Additionally, meeting room re-schedule program 122 may provide to a determined authorized invitee one or more notices of multiple instances of an unavailable meeting room for a repeating meeting. Meeting room re-schedule program 122 sends and receives information from computers 130A-130N and other computing devices not depicted in FIG. 1. While depicted as a separate program, in an embodiment, the functions and code of meeting room re-schedule program 122 are included in meeting scheduling service 121.

In the depicted embodiment, calendar database 125, meeting room database 126, networking database 128 and employee information database 129 reside on server 120. In another embodiment, calendar database 125, meeting room database 126, networking database 128 and employee information database 129 may reside elsewhere within distributed data processing environment 100 provided meeting room re-schedule program 122 and meeting scheduling service 121 have access to each of the databases. While each of calendar database 125, meeting room database 126, networking database 128 and employee information database 129 are depicted as a single database, in various embodiments, the information stored in each database may be stored in more than one database.

Calendar database 125 is a repository for data used by meeting scheduling service 121 and meeting room re-schedule program 122 to determine user or invitee availability using conventional meeting scheduling methods. Calendar database 125 stores information on a user's availability for scheduling a meeting. Meeting room database 126 is a repository for data on meeting room availability used by meeting scheduling service 121 and meeting room re-schedule program 122 to determine and reserve a meeting room or to re-schedule a meeting room for a meeting using conventional meeting scheduling methods.

Networking database 128 is a repository for data on employee networking sites that may include blogs, communities of shared information on specific projects, departments, or areas of a business, and the like. Networking database 128 may include information such as project details, employee project responsibilities, employee associates, titles, length of time on a project, areas of technical expertise, etc. Employee networking information may be used by meeting room re-schedule program 122 to determine relevance of an invitee, or a set of invitees, to a scheduled meeting.

Employee information database 129 is a repository for conventionally stored data corresponding to an employee or an invitee such as name, title, userid, phone numbers, department, and the like. Employee information database 129 may be utilized by meeting scheduling service 121 and meeting room re-schedule program 122 to determine one or more invitee userid's for sending e-mail or a meeting notice using known meeting scheduling methods.

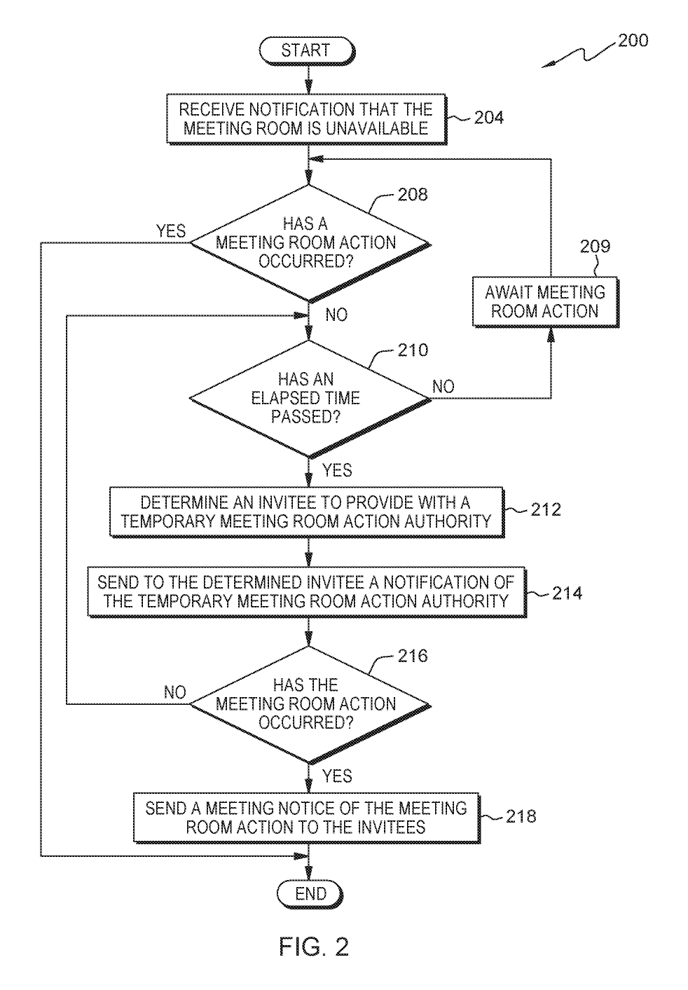

FIG. 2 is a flowchart depicting one example of a meeting room re-schedule method 200 in accordance with at least one embodiment of the present invention. As depicted, FIG. 2 includes the steps of a meeting room re-schedule method 200 performed by a program such as meeting room re-schedule program 122 on server 120 that is used when a selected meeting room for a scheduled meeting becomes unavailable, for example, when a meeting is bumped or removed from a scheduled meeting room by an owner or administrator of the selected meeting room.

Meeting room re-schedule method 200 includes receiving a notification that the meeting room is unavailable (204). For example, when two meeting chairs simultaneously book the same meeting room or when a higher priority meeting needs a meeting room, a meeting room reservation or selection by a meeting chair may be rejected or cancelled. Meeting scheduling service 121 sends a notification to the meeting chair and meeting room re-schedule method 200 when a meeting room reservation is cancelled. The notification may include conventional information on the meeting such as meeting title, a meeting date or meeting dates in a repeating meeting, time, and the unavailable meeting room. Additionally, the notification of the unavailable meeting room or unavailable meeting rooms, as may be the case in a repeating meeting, includes an instruction to the meeting chair to take an action such as cancel the meeting or reschedule the meeting room for the cancelled meeting room reservation(s). In an embodiment, the notification includes a timeframe in which to perform a meeting room action such as re-scheduling the unavailable meeting room.

Meeting room re-schedule method 200 determines whether a meeting room action has occurred (decision 208). A meeting room action as used with meeting room re-schedule program 122 includes re-scheduling a meeting room and cancelling a meeting. In an embodiment, a meeting room action includes re-scheduling a meeting. Meeting room re-schedule method 200 may query one or more of a system log, a database, or persistent storage in the meeting chair's computer (e.g., computer 130A), or a database such as meeting room database 126 on server 120 (depicted in FIG. 1) to determine that a meeting action has occurred (yes branch decision 208). In an embodiment, a meeting scheduling service (e.g., meeting scheduling service 121 depicted in FIG. 1) sends a notification of a meeting chair or other authorized meeting representative or user completing a meeting room action such as re-scheduling a meeting room for a previously scheduled meeting. When meeting room re-schedule method 200 determines that a meeting room action has occurred (e.g., the meeting room is re-scheduled), either by a query or a notification received from meeting scheduling service 121, then meeting room re-schedule method 200 ends.

However, if meeting room re-schedule method 200 determines that a meeting action has not occurred (no branch decision 208) using the methods discussed above, then meeting room re-schedule method 200 determines whether an elapsed time has passed (decision 210). An elapsed time in meeting room re-schedule method 200 is a time interval in which a meeting chair or other authorized user may take a meeting room action (e.g., selecting a revised meeting room) without further action by meeting room re-schedule method 200.

An elapsed time is configured in meeting room re-schedule method 200 as a pre-set or fixed elapse time, a variable elapsed time, which may be a determined elapse time, or a user selectable elapsed time. A fixed or pre-set elapsed time may be a default time interval for the elapsed time that is configured in a program (e.g., meeting room re-schedule program 122 depicted in FIG. 1). For example, meeting room re-schedule method 200 is pre-set with a fixed elapsed time of twenty-four hours. A variable elapsed time is an elapsed time or a time interval that may change for each received notice of an unavailable meeting room. For example, meeting room re-schedule method 200 is configured to determine a variable elapsed time based on a fraction or a percentage of the time remaining until the scheduled meeting. A variable elapsed time may be 1/10th or 0.10 of the time remaining until the scheduled meeting, for example, the notification is received 48 hours from the schedule meeting time then, the variable elapsed time would be 4.8 hours.

In an embodiment, meeting room re-schedule method 200 is configured to determine an elapsed time based, at least in part, on meeting room availability based, at least in part, existing prediction algorithms and historical data of meeting room availability. For example, meeting room re-schedule method 200 determines an elapsed time based on a prediction of a time when only three meeting rooms will be available at a location using historical data of meeting room availability (e.g.,, retrieved from meeting room database 126 depicted in FIG. 1). In this example, for a specific organization location with multiple meeting rooms, an elapsed time of twelve hours is used when known meeting room availability algorithms predict only three meeting rooms will be available in twelve hours based on an analysis of historical meeting room availability retrieved from a database with stored information on meeting room availability (e.g., meeting room database 126 in FIG. 1). In an embodiment, meeting room re-schedule method 200 includes checking or updating the elapsed time on a pre-determined schedule (e.g., every two weeks). For example, the elapsed time is determined or updated every two weeks using the meeting room prediction algorithms and updated historical meeting room availability retrieved from a meeting room database.

In another example, a variable elapsed time is a programmatically determined elapsed time based on prediction algorithms that analyze a user's or a meeting chair's previous history in re-scheduling a meeting after receiving a notification of an unavailable meeting room for a scheduled meeting. In this example, a variable elapsed time is determined, at least in part, on an analysis of system log data or data stored on the user's meeting re-schedule room actions retrieved from a database or persistent storage in an invitee such as a meeting chair's computer or a server (e.g., computer 130A or server 120 in FIG. 1). Historical data analysis of the user's or meeting chair's previous actions may determine or predict that if a user does not re-schedule a meeting in five hours, the user typically does not re-schedule the unavailable meeting room or cancel the scheduled meeting unless further reminders or other system-generated actions are sent to the meeting chair.

In another example of a programmatically determined elapsed time, meeting room re-schedule method 200 determines an elapsed time based on a comparison of a fixed elapsed time and a variable elapsed time. Meeting room re-schedule method 200, in this example, compares a fixed elapsed time of eight hours and a variable elapsed time of six hours (e.g., 10 percent of 60 hours remaining until the scheduled meeting) and selects the lesser of the two elapsed times (i.e., six hours) to use as the elapsed time.

In various embodiments, meeting room re-schedule method 200 is configured to utilize a user selected elapsed time. For example, a user may be provided with a pop-up menu, an icon for a selection of elapsed time, a list of elapsed times, or a line to enter a desired elapsed time to be selected and used for a scheduled meeting in meeting room re-schedule method 200. In some embodiments, meeting room re-schedule method 200 is configured with a default selection for an elapsed time. For example, meeting room re-schedule method 200 default elapsed time is 24 hours which may be user selected default or a pre-set default.

If meeting room re-schedule method 200 determines that the elapsed time has not passed (no branch decision 210), then meeting room re-schedule method 200 includes awaiting a meeting room action (209). Meeting room re-schedule method 200 is configured to check if a meeting room action has occurred. For example, meeting room re-schedule method 200 is configured to check every ten minutes to see if a meeting action has occurred (e.g., by querying a meeting log, a system log, a meeting room database, a calendar database, an e-mail log for a meeting room change notice, etc. on a meeting chair's or invitee's computer or server 120 in FIG. 1). In various embodiments, meeting room re-schedule method 200 includes receiving a notification of a meeting room action from a meeting scheduling service (e.g., meeting scheduling service 121).

However, if meeting room re-schedule method 200 determines that the elapsed time has passed (yes branch of decision 210), then meeting room re-schedule method 200 includes determining an invitee to provide with a temporary meeting room action authority (212). Meeting room re-schedule method 200 determines a user who is an invitee to the scheduled meeting with an unavailable meeting room to take a meeting action when a meeting chair does not (e.g., the meeting chair is out of the office, is unavailable, is busy or has forgotten the notification).

A user with a temporary meeting room re-schedule authority has the ability to take a meeting room action such as cancel the meeting or schedule another meeting room for the identified scheduled meeting or meetings with a cancelled meeting room or meeting rooms as may be the case in a repeating scheduled meeting. Unless otherwise specified in the case of a repeating meeting with multiple instances of cancelled meeting room reservations, the authorized user may only take a meeting room action such as re-schedule the unavailable meeting room for the identified scheduled meeting. In various embodiments, meeting room re-schedule method 200 provides an authorized user with the ability to take a meeting room action for one or more of multiple instances of a cancelled meeting room reservation for one or more unavailable meeting rooms in a repeating scheduled meeting.

Meeting room re-schedule method 200 determines an invitee to provide with the temporary meeting room action authority by one of several methods. Meeting room re-schedule method 200 determines an importance or relevance of invitees to the scheduled meeting based, at least in part, on a correlation of information on the invitees to one or more of a meeting context, meeting content, and a user or invitee availability.

In one embodiment, meeting room re-schedule method 200 uses existing algorithms defined for content relevance mapping. Context relevance mapping algorithms may determine a meeting context using extracted information from a meeting notice and/or retrieved information from a database such as calendar database 125 for the scheduled meeting. Context relevance mapping algorithms for the meeting may use information such as a meeting subject, a meeting agenda, meeting minutes, or meeting action items extracted from the scheduled meeting notice. In an embodiment, when a meeting notice includes only the meeting location, the meeting time, and the attendees, meeting room re-schedule method 200 includes retrieving from one or more databases (e.g., employee information database 129 or networking database 128) information on the invitee's such as projects working on, job title, and job description to determine a meeting context based on an analysis of the projects each of the invitees are working on and each of the invitee's job description. In one embodiment, when a meeting notice includes only the meeting location, the meeting time, and the attendees, meeting room re-schedule method 200 includes determining the most relevant invitee based, at least in part, on an invitee with the highest job title. Meeting room re-schedule method 200 may use known natural language processing and/or semantic analysis method to determine meeting context. In various embodiments, meeting room re-schedule method 200 uses natural language processing and/or semantic analysis of a meeting notice, elements included in the meeting notice such as an agenda, meeting minutes, action items, etc. and in analyzing invitee information extracted from one or more databases (e.g., employee information database 129).

Meeting room re-schedule method 200 includes retrieving information on each of the meeting invitees retrieved from one or more databases (e.g., an employee database such as employee information database 129, a user or corporate networking database such as networking database 128, or another database). Information retrieved from a database of employee or invitee information (e.g., employee information database 129), from a database on professional networking (e.g., networking database 128), or from another database storing invitee related invitee information may include information such as job title, time in a company, time on a project, projects the invitee is working on, invitee project roles, education, and technical expertise, and the like.

Meeting room re-schedule method 200 creates a prioritized list of invitees and uses the prioritized list to determine the invitee to provide with an authorization to re-schedule the meeting room (or cancel the meeting with an unavailable meeting room). Meeting room re-schedule method 200 compares the meeting context for the scheduled meeting to the retrieved invitee information such as job title, job description, programs affiliated with, time in a company and/or a project to determine the relevance of each invitee to the meeting to the meeting context. The prioritized list of invitees is a list in an ascending order of relevance or importance to the scheduled meeting (i.e., from most relevant to least relevant invitee). The prioritized list of invitees determines the most relevant invitee to provide with a temporary meeting room action authority. In various embodiments, the invitee with the highest relevance to the meeting context is the first invitee on the prioritized list (e.g., the first invitee provided with the temporary meeting room action authority).

In determining an invitee to provide with a temporary meeting room action authority, meeting room re-schedule method 200 includes selecting the invitee with the highest or the most relevance to the scheduled meeting (e.g., most relevance to a meeting context such as a meeting content or a meeting subject). For example, meeting room re-schedule method 200 determines the most relevant invitee based on the relevance of each of the meeting invitees determined by analyzing retrieved invitee data to a meeting context. Meeting room re-schedule method 200 includes analyzing invitee information such as a job description, a job title, department, projects working on, and length of time on a project retrieved from one or more databases (e.g., employee information database 129 and networking database 128) for each of the invitees to the meeting to find the invitee with the best or closest correlation of at least one of a job description, a job title, department, and projects working on to a meeting context. For example, the most relevant invitee to the meeting context of a meeting on customer satisfaction for product Y is the quality engineer for product Y whose job description includes the phrase “responsible for customer satisfaction” and “assigned to project Y.” In one embodiment, meeting room re-schedule method 200 determines a relevance to a meeting context for the prioritized list of invitees based, at least in part, on a correlation of the number key words in the retrieved invitee information matching one or more key words in the meeting context (e.g., the most relevant invitee's information provides the most key words that are not words such as a, the, etc. matching the meeting context, and so on). In one embodiment, meeting room re-schedule method 200 is configured to determine invitee relevance to a meeting context based, at least in part, on a length of time on a project included in a meeting context (e.g., the invitee with to most time or longest time on the project is determined to be the most relevant to the project, and so on). In various embodiments, meeting room re-schedule method 200 is configured to determine invitee relevance based, at least in part, an invitee with information matching at least a part of the meeting context who is in the same department as the meeting. In an embodiment, meeting room re-schedule method 200 uses existing knowledge-based algorithms and an analysis of an organization hierarchy for a company to determine the relevance of the invitee's with respect to the meeting context. Meeting room re-schedule method 200 provides the invitee with the most relevance to the scheduled meeting with the ability to perform a meeting room action such as re-scheduling the unavailable or cancelled meeting room.

In various embodiments, meeting room re-schedule method 200 includes determining the invitee with the highest or most relevance to the scheduled meeting who is available to perform a meeting room action. For example, meeting room re-schedule method 200 verifies if the invitee with the most relevance to the scheduled meeting is available (e.g., not travelling, on vacation, or scheduled in meetings) by querying a calendar database (e.g., calendar database 125 in FIG. 1) to verify if the most relevant invitee is available (e.g., for a pre-set time such as the next 48 hours). In various embodiments, meeting room re-schedule method 200 is configured to use the elapsed time as the pre-set time for determining invitee availability. In an embodiment, meeting room re-schedule method 200 is configured with a pre-set time for invitee availability based on the time to the scheduled meeting, for example, six hours for a meeting scheduled in less than three days. If meeting room re-schedule method 200 determines the invitee with the highest relevance to the schedule meeting is not available in the pre-set time, then meeting room re-schedule method 200 determines another invitee with the next most or next highest relevance to the scheduled meeting who is available in the pre-set time to take a meeting action on the scheduled meeting.

Meeting room re-schedule method 200 sends a notification to the determined invitee of the temporary meeting room action authority (214). The invitee determined to be the most relevant, available invitee for the scheduled meeting receives an e-mail, a note, a text, a short messaging service message, or other known electronic notification of the meeting room action authority for the scheduled meeting. The notification includes information on the scheduled meeting such as the meeting subject, the date of the meeting, the time of the meeting, and the location of the unavailable meeting room. In an embodiment, the notification to the determined invitee with temporary meeting room action authority includes a link to a meeting scheduling service (e.g., meeting scheduling service 121 in FIG. 1) to search available meeting rooms and to generate a meeting notice to all of the invitees to the scheduled meeting if the determined invitee decides to take a meeting room action (e.g., re-schedule the meeting room). In an embodiment, the notification to the determined invitee includes the elapsed time in which to complete the meeting room action.

Meeting room re-schedule method 200 determines whether a meeting room action has occurred (decision 216) using the methods (e.g., searching a system log, querying a database, etc.) previously discussed above with respect to step 208 for determining if a meeting action has occurred.

When meeting room re-schedule method 200 determines a meeting action has not occurred (no branch of decision step 216) using the previously discussed methods, then meeting room re-schedule method 200 includes determining whether an elapsed time has passed (decision 210) by comparing the time of the received notification and the current time. In this case, if the determined elapsed time has passed, meeting room re-schedule method 200 may determine a second invitee to provide with an authority to re-schedule the scheduled meeting.

However, if meeting room re-schedule method 200 determines that a meeting room action has occurred (yes branch of decision 216), then the method 200 sends a meeting notice of the meeting room action to the invitees (218). When the authorized invitee has either re-scheduled the meeting room or cancelled the scheduled meeting and invitees are notified, meeting room re-schedule method 200 ends. In an embodiment, meeting room re-schedule method 200 includes sending the meeting room action information to meeting scheduling service 121 to send notifications to the invitees.

While most of the description above is directed at a specific scheduled meeting, as previously mentioned, in various embodiments, meeting room re-schedule method 200 receives a notification of one or more instances of a scheduled repeating meeting with one or more unavailable meeting rooms. For example, meeting room re-schedule method 200 may receive a notification that a selected meeting room in the scheduled repeating meeting is not available for four of the scheduled meeting dates. Meeting room re-schedule method 200 may be configured, for example, with a link to a meeting room database for each instance of the unavailable meeting room. In another example, meeting room re-schedule method 200 may be configured to automatically proceed from the first instance to the second instance of an unavailable meeting room as the authorized invitee takes an action (e.g., re-schedules the unavailable meeting room) for the first instance, and so on until all instances are resolved by a meeting room action.

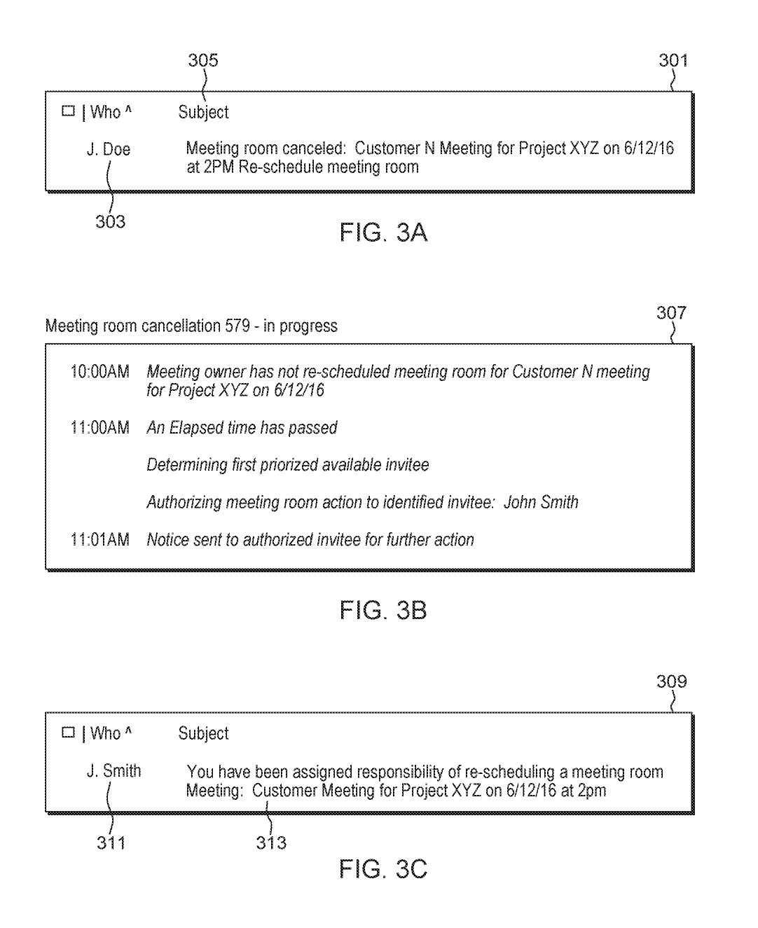

FIGS. 3A, 3B, and 3C are illustrations depicting examples of user interface displays of e-mails and computer log data generated by meeting room re-schedule program 122 in accordance with at least one embodiment of the present invention. As depicted, FIG. 3A is an example of a notification sent to a meeting chair, FIG. 3B is an example of a system log for a scheduled meeting with a cancelled meeting room, and FIG. 3C is an example of a notification to a determined invitee provided with a temporary meeting room action authority.

FIG. 3A depicts an example of an e-mail sent as notification 301 of a rejected or declined meeting room reservation. Notification 301 is sent to meeting chair 303 who is J. Doe. Notification 301 informs meeting chair 303 that the meeting room reservation for a scheduled meeting has been cancelled. Notification 301 for the scheduled meeting “Customer N Meeting for Project XYZ” identified in e-mail subject 305 informs meeting chair 303 (i.e., J. Doe) of an unavailable meeting room for the scheduled meeting. The e-mail or notification 301 when opened may include links to a meeting room database, such as meeting room database 126, or to a meeting scheduling service such as meeting scheduling service 121 (shown in FIG. 1).

FIG. 3B depicts an example of a system log for meeting room cancellation number 579 with system log entries 307. System log entries 307 include a timestamp and a history of some of the actions performed by a meeting room re-schedule program such as meeting room re-schedule program 122 using a meeting room re-schedule method as discussed in FIG. 2. System log entries 307 identify that at 11:00 am the elapsed time has passed (e.g., 24 hours). Meeting room re-schedule program 122 analyzes the meeting subject and invitee information retrieved from one or more databases such as employee information database for John Doe, Joe Smith, and Dale Jones (i.e., the meeting invitees) to compare the meeting context and the extracted information on the meeting invitee job descriptions. Meeting re-schedule program 122 determines that Joe Smith, the customer account manager for Customer N is the most relevant, available invitee to the scheduled meeting and the program sends a notification to J. Smith of the authorization (depicted in FIG. 3C) to re-schedule the scheduled meeting with an unavailable meeting room.

FIG. 3C depicts an example of an e-mail sent as notification 309. Notification 309 informs J. Smith, authorized invitee 311, of a temporary authorization or responsibility to perform a meeting action for e-mail subject 313, the scheduled meeting “Customer N Meeting for Project XYZ” on Jun. 12, 2016. When opened, notification 309 may include links to a meeting room database, such as meeting room database 126 and/or to meeting scheduling service 121 (depicted in FIG. 1). Additionally, e-mail subject 313 may include an another or a third line that informs authorized invitee 311 that a meeting room action is needed in the next 24 hours (i.e., in the elapsed time as configured in meeting room re-schedule program 122).

FIG. 4 is block diagram 400 depicting components of a computer system in accordance with at least one embodiment of the present invention. As depicted, FIG. 4 depicts the components of a computer system, which is an example of a system such as server 120 or computers 130A-130N within distributed data processing environment 100, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Server 120 and computers 130A-130N include processor(s) 404, cache 416, memory 406, persistent storage 408, communications unit 410, input/output (I/O) interface(s) 412, and communications fabric 402. Communications fabric 402 provides communications between cache 416, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of processor(s) 404 by holding recently accessed data, and data near recently accessed data, from memory 406.

Program instructions and data used to practice embodiments of the present invention are stored in persistent storage 408 for execution and/or access by one or more of the respective processor(s) 404 via cache 416. In this embodiment, persistent storage 408 includes a magnetic hard disk drive. Alternatively, or in addition to a magnetic hard disk drive, persistent storage 408 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is part of persistent storage 408.

Communications unit 410, in these examples, provides for communications with other data processing systems or devices, including among resources of computers 130A-130N, server 120, and other computing devices not shown in FIG. 1. In these examples, communications unit 410 includes one or more network interface cards. Communications unit 410 may provide communications with either or both physical and wireless communications links. Program instructions and data used to practice embodiments of the present invention may be downloaded to persistent storage 408 through communications unit 410.

I/O interface(s) 412 allows for input and output of data with other devices that may be connected to server 120 and computers 130A-N. For example, I/O interface(s) 412 may provide a connection to external device(s) 418 such as a keyboard, a keypad, a touch screen, a microphone, a digital camera, and/or some other suitable input device. External device(s) 418 can also include portable computer readable storage media, for example, devices such as thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a computer monitor. Display 420 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application, or technical improvement over technologies found in the marketplace, or to enable others of ordinary skill in the art to understand the embodiments disclosed herein.

What is claimed is:

1. A method comprising:
receiving, by one or more computer processors, a notification of an unavailable meeting room for a scheduled meeting;
determining, by the one or more computer processors, a meeting context based, at least in part, on at least one of a meeting subject, a meeting agenda, a plurality of meeting minutes, or one or more meeting action items using at least one of natural language processing or semantic analysis;
determining, by the one or more computer processors, whether an elapse time for a meeting room action is past for the scheduled meeting with the unavailable meeting room;
responsive to determining the elapse time for the meeting room action is past for the scheduled meeting with the unavailable meeting room, determining, by the one or more computer processors, a first invitee on a prioritized list of a plurality of meeting invitees to the scheduled meeting to provide with a temporary meeting room action authorization, wherein the prioritized list is in ascending order from a most relevant invitee to a least relevant invitee to the scheduled meeting and wherein the ascending order is determined by at least one of a comparison of information on each invitee of the plurality of meeting invitees to one or more of the meeting context, an invitee length of time on a project associated with a meeting subject of the scheduled meeting, or an invitee availability, wherein the comparison of information is based, at least in part, on one of a correlation of a number of key words in the retrieved information matching one or more key words in the meeting context, a length of time in the project, or the most relevant invitee available for the pre-set time;
sending, by the one or more computer processors, to the first invitee, a notification of the temporary meeting room action authorization for the scheduled meeting;
determining, by the one or more computer processors, whether the first invitee has performed a meeting room action in a second elapse time;
responsive to determining the meeting room action is not performed for the scheduled meeting in the second elapse time, determining, by the one or more computer processors, a second invitee on the prioritized list on the plurality of meeting invitees to provide with a temporary meeting room action authorization; and
sending, by the one or more computer processors, a notification of the temporary meeting room action authorization to the second invitee.
